(19) United States
(12) Patent Application Publication
(10) Pub. No.: US 2007/0016114 A1
(43) Pub. Date: Jan. 18, 2007

(54) Lithotripsy method and system without patient relocation between diagnostic imaging and treatment

(76) Inventors: Gerhard Buchholtz, Erlangen (DE); Jens Fehre, Hausen (DE); Bernd Granz, Oberasbach (DE); Martin Hoheisel, Erlangen (DE); Werner Kruft, Erlangen (DE); Markus Lanski, Furth (DE); Matthias Mahler, Erlangen (DE); Christian Meinert, Marloffstein (DE); Thomas Mertelmeier, Erlangen (DE); Ralf Nanke, Neunkirchen (DE); Manfred Rattner, Grossenseebach (DE)

Correspondence Address: SCHIFF HARDIN, LLP;PATENT DEPARTMENT, 6600 SEARS TOWER, CHICAGO, IL, 60606-6473, US

(21) Appl. No.: 11/478,889

(22) Filed: Jun. 30, 2006

(30) Foreign Application Priority Data
Jul. 4, 2005 (DE) 10 2005 031 125.3

(51) Int. Cl. A61H 1/00

(52) U.S. Cl. 601/4

(57) ABSTRACT

In a method to disintegrate a calculus in a patient by shockwave lithotripsy, a 3D image data set of the patient is generated in a first step; the shockwave lithotripsy is conducted in a second step; and first step and second step are conducted with an unchanged position of the patient. A lithotripsy system to disintegrate a calculus in a patient has a shockwave system to disintegrate the calculus and a 3D imaging system to generate a 3D image data set of the patient without movement of the patient.

### BACKGROUND OF THE INVENTION

1. Field of the Invention

The invention concerns a method and a lithotripsy system used to disintegrate a calculus in a patient, normally living people or animals.

2. Description of the Prior Art

Lithotripsy systems are used to disintegrate calculi such as, for example, kidney, bladder, ureter or gall stones. The destruction of the calculus inside the patient ensues in shockwave lithotripsy by ultrasound shockwaves that are emitted by a shockwave head of a lithotripsy system, normally tapering conically and being concentrated at a focal point.

The main task of lithotripsy is to place the focal point of the ultrasonic shockwave as exactly as possible in the center of the calculus to be disintegrated or one of its fragments. The energy application inside the calculus is thus no more than that which leads to the best possible destruction thereof. This also protects the patient as well as possible from unwanted side effects, since the ultrasonic shockwaves minimally strike the rest of the body of the patient. If such shockwaves are inaccurately targeted at the calculus, this can lead to injury of the patient such as, for example, a kidney hematoma in the case of a kidney lithotripsy.

A patient exhibiting calculus normally seeks out a doctor due to painful discomforts in order to determine the cause. This doctor diagnoses the calculus with an x-ray method, usually today with a tomographic 3D x-ray method. The doctor hereupon schedules a shockwave lithotripsy that is implemented on the patient at a later point in time, for example a few days after the diagnosis.

The patient is x-rayed again at the point in time of the lithotripsy, with at least two x-ray exposures in two different planes normally being necessary in order to locate the calculus and to position the shockwave focus.

This procedure exhibits various disadvantages: two separate procedures, namely the diagnosis exam and the lithotripsy, must be administered in the workflow of a medical practice or clinic. Respective accommodations, apparatuses and personnel must be booked or reserved for this; the patient must be scheduled twice; patient or treatment data must be stored and associated. Even in this case of temporally- and/or spatially-proximal execution of diagnosis and lithotripsy, for example within a hospital on a single day, the patient must still be relocated between a tomography system for diagnosis and a lithotripter for shockwave treatment. The position of the internal organs or of the calculus in the patient thus inevitably changes at least slightly. Due to the repositioning, at least determination of the new location of the calculus in the patient with x-rays is necessary in the lithotripsy. The patient is exposed to x-rays at two different points in time.

### SUMMARY OF THE INVENTION

It is an object of the present invention to provide an improved method and an improved lithotripsy system to disintegrate a calculus in a patient.

With regard to the method, this object is achieved by a method to disintegrate a calculus in a patient by shockwave lithotripsy in which a 3D image data set of the patient is generated in a first step; the shockwave lithotripsy is conducted in a second step, and first and second steps are implemented with an unchanged support of the patient.

Because the patient is not repositioned between the first step and the second step, several advantages are achieved: the position of internal organs and of the calculus in the patient do not change. The generated 3D image data set of the patient that serves for diagnosis of the calculus additionally gives information about the exact position of the calculus. Given the actual stone destruction in the second step, no further x-ray exposure of the patient thus needs to ensue. Locating of the stone location can be implemented directly using the 3D image data set. Diagnosis and destruction are equally completed in a single step.

No new x-ray location of the calculus thus is necessary for the shockwave lithotripsy. The patient is only exposed to x-ray radiation once, namely in the first step. The advantage for the workflow in a hospital or a medical practice is that accommodations, personnel and apparatuses must only be scheduled for a single treatment date in which both steps are executed. The patient must only keep a single appointment.

The apparatus coordinate systems that apply for the generation of the 3D image data set and the lithotripsy system can easily be matched to one another or can be registered to one another via known measures. For example, it is thus possible to mechanically securely couple an x-ray system suitable for generation of the 3D data set to a shockwave system and to align these relative to one another. Alternatively or additionally, commercially available 3D positioning systems can be used in order to determine the mutual position of 3D x-ray system and shockwave system and to correlate their apparatus coordinate systems with one another. In such a case a mobile x-ray apparatus can also be used that can be removed from the patient or the treatment area around the patient after generation of the 3D image data set in order to achieve sufficient access to the patient during the lithotripsy.

The lithotripsy is improved by the inventive method by precise knowledge and monitoring of the anatomical conditions before, during and after the shockwave lithotripsy, due to the availability of the 3D image data set during the shockwave lithotripsy, as long as the patient is not repositioned. The irradiation direction and other parameters of the shockwave lithotripsy thus can be optimally adapted to the patient or his or her anatomical conditions since these are better recognizable in the 3D image data set than in conventional x-ray exposures for stone location.

The alignment of the shockwave focus on the calculus can ensue on the part of the doctor or automatically through the lithotripsy system.

For progress monitoring and relocation, further 3D image data sets can be acquired at any time in the course of the shockwave lithotripsy. Alternatively or additionally, with this x-ray radiation naturally only individual 2D image's can also be used for this purpose, thus for the progress monitoring and relocation.

The position and/or the composition of the calculus can additionally be determined from the 3D image data set, and at least one shockwave parameter for the shockwave lithotripsy can be selected dependent on the position and/or composition of the calculus. For example, from B. J. Heismann et al., J. Appl. Phys. 94(3), 2003, 2073-2079 and P. Joseph et al., J. Urol. 167(5), 2002, 1968-1971 it is known to determine the chemical composition of a calculus from a 3D image data set of a tomographic method. The shockwave parameters then can be optimally adjusted to the calculus to be destroyed in order to execute the disintegration as quickly and effectively as possible. The shockwave lithotripsy is thus made dependent on the stone type and thus is improved.

A 3D image data set of the patient can be generated after the shockwave lithotripsy. A step comparable to the first step thus can be alternatively or additionally executed during and/or after the second step, thus the actual shockwave lithotripsy. This also can ensue given an unchanged position of the patient. The 2D image data set thus supplies a direct monitoring or comparison possibility in order, for example, to be able to monitor the treatment result and possibly also complications (such as, for example, a kidney hematoma) after the shockwave lithotripsy. In the event that it is necessary, immediate countermeasures such as, for example, a post-treatment by continuation of the shockwave lithotripsy or a corresponding treatment of the complications can ensue. A post-treatment at a later point in time thus can be dispensed with for the patient. The advantages cited above also apply for the patient and workflow.

With regard to the lithotripsy system, the above object is achieved by a lithotripsy system to disintegrate a calculus in a patient, with a shockwave system and with a 3D imaging system to generate a 3D image data set of the patient without movement of the patient.

The advantages of the lithotripsy system have already been explained in detail above in connection with the method. The possibilities of -integration of shockwave system and 3D imaging system have also been explained above with regard to the respective apparatus coordinate systems within a lithotripsy system.

The lithotripsy system can include an evaluation unit for evaluation of the 3D image data set with regard to the composition of the calculus and a control unit to adjust a shockwave parameter of the shockwave system dependent on the composition.

The lithotripsy system is able to (as described above) conduct an effective lithotripsy, namely a lithotripsy adapted to the current properties or, respectively, the composition of the calculus.

### DESCRIPTION OF THE DRAWINGS

The single figure shows a lithotripsy system with a 3D imaging system and a shockwave system for a shockwave lithotripsy on a patient in accordance with the invention.

### DESCRIPTION OF THE PREFERRED EMBODIMENTS

The FIGURE shows a lithotripsy system 2 with a patient 4. The lithotripsy system 2 has a 3D x-ray apparatus 6, a shockwave system 8 and a patient table 12 which are permanently connected to the floor 20 of a treatment room (not shown) via respective bases 14 and 18, and are thus arranged in a fixed spatial relation to one another. The 3D x-ray apparatus 6 and shockwave system 8 are connected via a system controller 10. Due to the known spatial association of the apparatuses relative to one another, the spatial position of all components of the lithotripsy system 2 in their apparatus frame of reference is known to the system controller 10 at every point in time. Alternatively, a movable system can be used with components that are situated in a known spatiail relation to one another.

The treatment situation shown in the FIGURE has the following case history. The patient 4 has had pain in the abdomen for two weeks. Ten days ago he visited his primary care physician (not shown), who examined him but did not x-ray him. Since the primary care physician suspected a kidney stone in the patient 4 based on the symptoms, the physician referred the patient to the combined 3D x-ray examination (shown in the FIGURE) with the option of immediate lithotripsy given acknowledgement of the symptomatic suspicion of the primary care physician.

A sedative was administered to the patient 4, so the patient 4 barely changes body position during the entire time. The patient 4, who exhibits a kidney stone 22 internally, rests during the entire lithotripsy described in the following, therefore in the dorsal position on the table plate 24 of the patient table 12.

At the ends of the C-arm, the 3D x-ray apparatus 6 carries an x-ray source 30 for emission of x-ray radiation indicated by the central ray 28 toward a planar detector 32. The x-ray source 30 and planar radiation detector 32 orbit the patient 4 in a known manner (not shown) in order to acquire a 3D image data set 26 of the patient 4 that is stored in the system controller 10 or an image system (not shown) thereof.

With the aid of the system controller 10, the doctor (not shown) conducting the examination evaluates the 3D image data set 26 and actually diagnoses a kidney stone 22 in the patient. With the aid of the system controller 10, the doctor additionally determines the position in the patient 4, size and chemical properties of the kidney stone 22 via suitable image processing and other methods. Moreover, the system controller 10 determines the geometric support or position of the kidney stone 22 in the apparatus reference system.

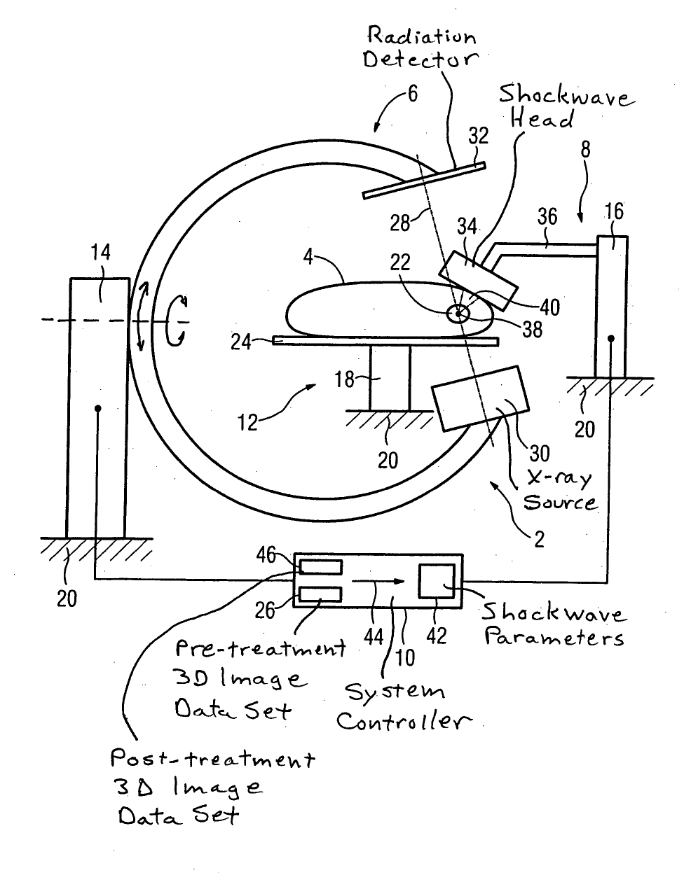

Since the kidney stone 22 is now clearly diagnosed and characterized, a lithotripsy is immediately conducted on the patient, i.e. as mentioned above without the patient being repositioned on the patient table 12. For this, the shockwave system 8 comprises a shockwave head 34 on a support arm 36, which shockwave head 34 generates a shockwave cone 40 of ultrasonic shockwaves that are concentrated at a focal point 38. Since, as mentioned above, the mutual relative positions of the system parts (shown in FIG. 1) of the lithotripsy system 2 are known in the system controller 10, the shockwave head 34 is aligned such that the focus point 38 comes to lie in the center of the kidney stone 22.

With the ultrasonic shockwaves emitted by the shockwave head 34, the kidney stone 22 is exposed to these ultrasonic shockwaves until it is sufficiently fragmented in order to later be excreted by the patient 4 in a natural manner.

The shockwave parameters 42, for example energy level, shot frequency and total shot number of the ultrasonic shockwaves, are adapted (indicated by the arrow 44) by the system controller 10 to the properties of the kidney stone 22, determined as described above.

After the end of the shockwave therapy, according to the shockwave parameters 42 a further 3D image data set 46 of the patient is generated (again without repositioning him) with the aid of the x-ray apparatus 6. The success of the conducted shockwave lithotripsy is monitored by the doctor using the 3D image data set 46. The direct comparison possibility with the 3D image data set 26 acquired before the beginning of the treatment is available for this since both 3D image data set 26 and 3D image data set 46 have been acquired in the exact same body position of the patient.

Using this the doctor determines both whether the kidney stone 22 is sufficiently destroyed (thus no post-treatment of the patient 4 is necessary) and whether the kidney of the patient 4 has suffered no damage due to side effects of the shockwave lithotripsy.

Only now is the patient 4 relocated from the patient table 12 and removed from the lithotripsy system 2.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method for disintegrating a calculus in a patient by shockwave lithotripsy, comprising the steps of:
generating a 3D image data set of a patient in an imaging procedure;
disintegrating a calculus in the patient by shockwave lithotripsy in a lithotripsy procedure; and
conducting said imaging procedure and said lithotripsy procedure with an unchanged positioning of the patient therebetween.

2. A method as claimed in claim 1 comprising, from said 3D image data set, identifying an attribute of said calculus selected from the group consisting of a position of the calculus in the patient and composition of the calculus; and
setting at least one parameter of said lithotripsy procedure dependent on said attribute.

3. A method as claimed in claim 1 comprising generating another 3D image data set of the patient after said lithotripsy procedure.

4. A lithotripsy system comprising:
a patient support adapted to receive a patient thereon;
a 3D imaging system adapted to interact with the patient on the patient support to generate a 3D image data set of the patient; and
a shockwave system adapted to interact with the patient on the patient support to disintegrate a calculus in the patient, with the patient in a same position on the patient support during interaction with said shockwave system as during interaction with said imaging system.

5. A lithotripsy system as claimed in claim 4 comprising an evaluation unit that evaluates said 3D image data set to identify an attribute of the calculus selected from the group consisting of a position of the calculus in the patient and a composition of the calculus, and wherein said shockwave system comprises a control unit, connected to said evaluation unit, that adjusts at least one parameter of the shockwave system for disintegrating the calculus dependent on said attribute.
